(19) United States
(12) Patent Application Publication
(10) Pub. No.: US 2024/0060646 A1
(43) Pub. Date: Feb. 22, 2024

(54) COOKING APPARATUS AND CONTROLLING METHOD THEREOF

(71) Applicant: Samsung Electronics Co., Ltd., Suwon-si (KR)

(72) Inventor: Joonsik JUN, Suwon-si (KR)

(21) Appl. No.: 18/458,467

(22) Filed: Aug. 30, 2023

Related U.S. Application Data
(63) Continuation of application No. PCT/KR2023/006096, filed on May 4, 2023.

(30) Foreign Application Priority Data
Aug. 16, 2022 (KR) 10-2022-0102079

(51) Int. Cl. F24C 3/12; F24C 15/20; H04N 7/18; G06V 20/40

(52) U.S. Cl. CPC F24C 3/126; F24C 15/2021; H04N 7/183; G06V 20/40

(57) ABSTRACT

A cooking apparatus is provided. The cooking apparatus includes a plurality of burners for heating food, a communicator, and at least one processor configured to, based on transmission of information on the cooking apparatus being requested from an external apparatus through the communicator based on a streaming request for an image of the cooking apparatus photographed through a camera, control the communicator to transmit the information on the cooking apparatus including information on a burner that is being used among the plurality of burners to the external apparatus.

### CROSS-REFERENCE TO RELATED APPLICATION(S)

This application is a continuation application, claiming priority under § 365(c), of an International application No. PCT/KR2023/006096, filed on May 4, 2023, which is based on and claims the benefit of a Korean patent application number 10-2022-0102079, filed on Aug. 16, 2022, in the Korean Intellectual Property Office, the disclosure of which is incorporated by reference herein in its entirety.

### TECHNICAL FIELD

The disclosure relates to a cooking apparatus and a controlling method thereof. More particularly, the disclosure relates to a cooking apparatus including a plurality of burners, and a controlling method thereof.

### BACKGROUND ART

Homes wherein cook tops and range hoods are installed in kitchens are increasing.

A cook top may mean an electric range and/or a gas range that heats a cooking vessel (or, a subject for cooking) through one or a plurality of burners. A cook top may also be referred to as a cooking apparatus. A cook top may be implemented as a standalone type, or an oven range including an oven under the cook top.

A range hood located over a cook top may discharge smoke or odor generated in a cooking process to the outside through a fan. A range hood is one of ventilation apparatuses that can be installed in a kitchen, and it can be installed together with a cook top.

A user needs to continuously check the proceeding situation of cooking of a subject for cooking that is being cooked, overheating of a cooking vessel (or, a subject for cooking), or whether the subject for cooking is over cooked, or the like.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a cooking apparatus including a plurality of burners for heating food, a communicator, and at least one processor configured to, based on information on the cooking apparatus being requested from an external apparatus through the communicator based on a streaming request for an image of the cooking apparatus photographed through a camera, control the communicator to transmit the information on the cooking apparatus including information on a burner that is being used among the plurality of burners to the external apparatus.

Additional aspects will be set forth in part in the description which follows and, in part, will be apparent from the description, or may be learned by practice of the presented embodiments.

Also, the information on the burner that is being used includes information on the location where the burner that is being used is located on the cooking apparatus.

In addition, the information on the location where the burner that is being used is located includes information on coordinates of vertexes of a quadrangle surrounding the burner that is being used among a plurality of quadrangles respectively surrounding the plurality of burners.

Further, the processor may, based on the entire horizontal length and the entire vertical length of the cooking apparatus, the horizontal length and the vertical length of the quadrangle surrounding the burner that is being used, and the distance between the vertexes of the quadrangle surrounding the burner that is being used and the vertexes of the cooking apparatus, calculate the coordinates of the left upper vertex and the right lower vertex of the burner that is being used.

The processor may, based on receiving the information on the coordinates wherein the cooking apparatus is located in the entire image photographed through the camera from the external apparatus through the communicator, calculate the coordinates of the vertexes of the quadrangle surrounding the burner that is being used based on the information on the coordinates wherein the cooking apparatus is located.

In addition, the external apparatus may be a server that can communicate with a display apparatus wherein the streaming request is initiated, a range hood including the camera, and the cooking apparatus, and the server may transmit the information on the burner that is being used that was received from the cooking apparatus to the range hood, and transmit a streaming image of the cooking apparatus received from the range hood and the information on the burner that is being used to the display apparatus.

The display apparatus may display the burner that is being used in an enlarged size in the streaming image of the cooking apparatus based on the information on the burner that is being used.

In addition, the range hood may control the camera to photograph the burner that is being used in an enlarged size based on the information on the burner that is being used, and transmit a streaming image regarding the burner that is being used that was photographed in an enlarged size to the server.

The information on the burner that is being used further includes at least one of identification information of the burner that is being used, information on the operation level of the burner that is being used, or information on the time when the burner that is being used started operating.

In accordance with an aspect of the disclosure, a method of controlling a cooking apparatus including a plurality of burners for heating food is provided. The method includes, based on a streaming request for an image of the cooking apparatus photographed through a camera, receiving a request for information on the cooking apparatus from an external apparatus, and transmitting the information on the cooking apparatus including information on a burner that is being used among the plurality of burners to the external apparatus in response to the request for information.

The information on the burner that is being used includes information on the location where the burner that is being used is located on the cooking apparatus.

In addition, the information on the location where the burner that is being used is located includes information on coordinates of vertexes of a quadrangle surrounding the burner that is being used among a plurality of quadrangles respectively surrounding the plurality of burners.

Further, the method includes, based on the entire horizontal length and the entire vertical length of the cooking apparatus, the horizontal length and the vertical length of the quadrangle surrounding the burner that is being used, and the distance between the vertexes of the quadrangle surrounding the burner that is being used and the vertexes of the cooking apparatus, calculating the coordinates of the left upper vertex and the right lower vertex of the burner that is being used.

In accordance with another aspect of the disclosure, a method of controlling a cooking apparatus comprising a plurality of burners for heating food is provided. The method includes receiving the information on the coordinates wherein the cooking apparatus is located in the entire image photographed through the camera from the external apparatus, and calculating the coordinates of the vertexes of the quadrangle surrounding the burner that is being used based on the information on the coordinates wherein the cooking apparatus is located.

In addition, the external apparatus may be a server that can communicate with a display apparatus wherein the streaming request is initiated, a range hood including the camera, and the cooking apparatus, and the server may transmit the information on the burner that is being used that was received from the cooking apparatus to the range hood, and transmit a streaming image of the cooking apparatus received from the range hood and the information on the burner that is being used to the display apparatus.

Further, the display apparatus may display the burner that is being used in an enlarged size in the streaming image of the cooking apparatus based on the information on the burner that is being used.

Moreover, the range hood may control the camera to photograph the burner that is being used in an enlarged size based on the information on the burner that is being used, and transmit a streaming image regarding the burner that is being used that was photographed in an enlarged size to the server.

In addition, the information on the burner that is being used further includes at least one of identification information of the burner that is being used, information on the operation level of the burner that is being used, or information on the time when the burner that is being used started operating.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiment of the disclosure will be more apparent from the following description taken in conjunction with the accompanying drawings, in which:

FIG. 1A is a diagram illustrating a cooking system according to an embodiment of the disclosure;

FIG. 1B is a diagram illustrating an upper plate of a cooking apparatus according to an embodiment of the disclosure;

FIG. 1C is a diagram for illustrating an operation of a cooking system according to an embodiment of the disclosure;

FIG. 2 is a block diagram of a cooking apparatus according to an embodiment of the disclosure;

FIG. 3 is a diagram for illustrating a method of calculating information on a location of a burner according to an embodiment of the disclosure;

FIG. 4A is a diagram for illustrating an image displayed on a display apparatus according to an embodiment of the disclosure;

FIG. 4B is a diagram for illustrating an image displayed on a display apparatus according to an embodiment of the disclosure;

FIG. 4C is a diagram for illustrating an image displayed on a display apparatus according to an embodiment of the disclosure;

FIG. 5 is a diagram for illustrating a method of calculating information on a location of a burner according to an embodiment of the disclosure;

FIG. 6 is a block diagram of a cooking apparatus according to an embodiment of the disclosure;

FIG. 7 is a flow chart regarding a controlling method of a cooking apparatus according to an embodiment of the disclosure;

FIG. 8A is a diagram for illustrating calculating information on a location of a burner that is being used by a range hood according to an embodiment of the disclosure;

FIG. 8B is a diagram for illustrating calculating information on a location of a burner that is being used by a range hood according to an embodiment of the disclosure;

FIG. 9 is a diagram for illustrating calculating information on a location of a burner that is being used by a display apparatus according to an embodiment of the disclosure; and

FIG. 10 is a diagram for illustrating an embodiment of providing a streaming image of a cooking apparatus without using a server according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the disclosure, detailed descriptions of related known technologies will be omitted when it is determined that the descriptions may unnecessarily obscure the gist of the disclosure. In addition, overlapping descriptions of the same components will be omitted as far as possible.

The suffix “part” for components used in the following description is added or interchangeably used only based on the convenience in drafting the specification, and it does not have a distinguished meaning or role by itself.

In the disclosure, terms, such as ‘include’ and ‘have’ should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

In addition, the expressions “first,” “second,” and the like used in the disclosure may be used to describe various elements regardless of any order and/or degree of importance. In addition, such expressions are used only to distinguish one element from another element, and are not intended to limit the elements.

Meanwhile, in the disclosure, the description that one element (e.g., a first element) is “connected to” another element (e.g., a second element) should be interpreted to include both the case where the one element (e.g., a first element) is directly connected to the other element (e.g., a second element), and the case where the one element (e.g., a first element) is connected to the other element (e.g., a second element) through still another element (e.g., a third element).

In contrast, the description that one element (e.g., a first element) is “directly connected to” another element (e.g., a second element) can be interpreted to mean that still another element (e.g., a third element) does not exist between the one element (e.g., a first element) and the other element (e.g., a second element).

Further, the terms used in the embodiments of the disclosure may be interpreted as meanings generally known to those of ordinary skill in the art described in the disclosure, unless defined differently in the disclosure.

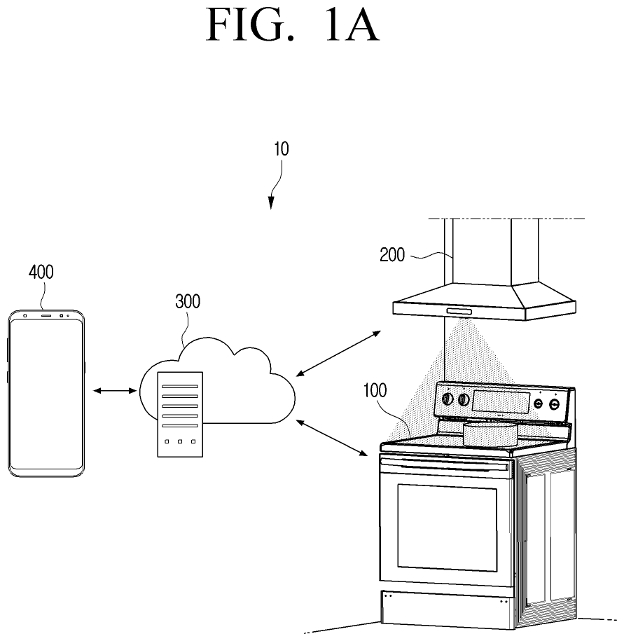

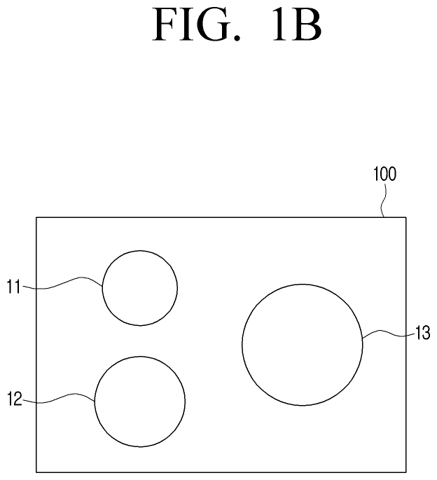

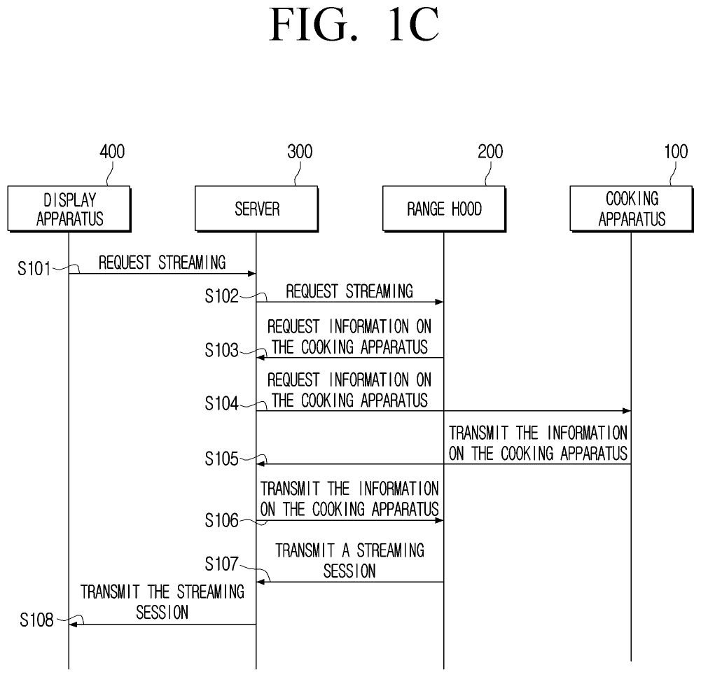

FIG. 1A is a diagram illustrating a cooking system according to an embodiment of the disclosure.

FIG. 1B is a diagram illustrating an upper plate of a cooking apparatus according to an embodiment of the disclosure.

FIG. 1C is a diagram for illustrating an operation of a cooking system according to an embodiment of the disclosure.

Referring to FIG. 1A, a cooking system 10 includes a cooking apparatus 100, a range hood 200, a server 300, and a display apparatus 400.

The cooking apparatus 100, the range hood 200, and the display apparatus 400 may be connected with the server 300 through various kinds of wired and wireless communication methods, and transmit and receive various kinds of signals.

The cooking apparatus 100 is an apparatus that can heat a cooking vessel or a subject for cooking through a plurality of burners 11, 12, 13 as illustrated in FIG. 1B, and according to one or more embodiments of the disclosure, the cooking apparatus 100 may be a cook top, such as an electric range or a gas range.

The range hood 200 may be located over the cooking apparatus 100, and may discharge smoke or odor generated in a cooking process to the outside through a fan. In particular, the range hood 200 may include a camera, and photograph the cooking apparatus 100 located below through the camera.

The display apparatus 400 is an apparatus that includes a display panel and can display various kinds of images, and according to one or more embodiments of the disclosure, the display apparatus 400 may be implemented as a mobile apparatus, such as a smartphone and a tablet. However, the disclosure is not limited thereto, and the display apparatus 400 may be implemented as various display apparatuses, such as a TV, a smart TV, a monitor electronic picture frame, a laptop computer, or the like.

A user needs to continuously check the proceeding situation of cooking of a subject for cooking that is being cooked, overheating of a cooking vessel (or, a subject for cooking), or whether the subject for cooking is over cooked, or the like.

For this, according to one or more embodiments of the disclosure, an image including the cooking apparatus 100 photographed through the camera of the range hood 200 may be transmitted to the display apparatus 400 through the server 300 or directly, and may be displayed on the display apparatus 400.

Accordingly, a user can check the cooking process through the display apparatus 400 (e.g., a television (TV) or a smartphone) in another place without having to stay around the cooking apparatus 100 while the subject for cooking is being cooked.

In particular, according to one or more embodiments of the disclosure, the display apparatus 400 may automatically enlarge a burner that is currently being used (i.e., a burner that is cooking the subject for cooking) among the plurality of burners 11, 12, 13 and display it, based on information on the cooking apparatus 100 provided at the cooking apparatus 100.

Accordingly, the user can conveniently identify the burner that is being used without having to manually manipulate to enlarge (e.g., a pinch to zoom manipulation) a portion of interest (i.e., the portion of the burner that is currently being used) in the entire image of the cooking apparatus 100 displayed on the display apparatus 400.

Meanwhile, on a burner that is being used, a cooking vessel is generally located and the burner is covered. Thus, in the case of identifying the area of the burner that is being used by using an image processing method, there is a high probability that an error may occur. However, according to one or more embodiments of the disclosure, information on the cooking apparatus 100 provided at the cooking apparatus 100 is used for displaying a burner that is being used in an enlarged size, and thus the area of the burner that is being used may be identified more correctly than in the case of using an image processing method, and may be enlarged.

FIG. 1C is a diagram for illustrating an operation of a cooking system according to one or more embodiments of the disclosure in an environment as in FIG. 1A.

Referring to FIG. 1C, the display apparatus 400 may request streaming of an image of the cooking apparatus 100 to the server 300 in operation S101. For example, in the display apparatus 400, a hood camera application for displaying an image of the cooking apparatus 100 photographed through the camera of the range hood 200 may be installed. When the hood camera application is executed, and a user instruction is input through the execution screen, the display apparatus 400 may request streaming of the image of the cooking apparatus 100 to the server 300 based on the input user instruction.

When the streaming request is received from the display apparatus 400, the server 300 may request streaming of the image of the cooking apparatus 100 to the range hood 200 in operation S102.

The range hood 200 that received the streaming request may request information on the cooking apparatus 100 to the server 300 for generating a streaming session including the information on the cooking apparatus 100 in operation S103.

The server 300 that received the request for the information on the cooking apparatus 100 from the range hood 200 may request the information on the cooking apparatus 100 to the cooking apparatus 100 in operation S104.

Accordingly, the cooking apparatus 100 may transmit the information on the cooking apparatus 100 including information on a burner that is being used to the server 300 in response to receiving the request for the information on the cooking apparatus 100 from the server 300 in operation S105.

Here, according to one or more embodiments of the disclosure, the information on the burner that is being used may include information on the location where the burner that is being used is located on the cooking apparatus 100.

Specifically, the cooking apparatus 100 stores information on the specification of the cooking apparatus 100 in a memory. Here, the information on the specification of the cooking apparatus 100 may include identification information of the cooking apparatus 100, such as the name, the unique number, or the like, of the cooking apparatus 100, information on the number of the burners included in the cooking apparatus 100, identification information of each burner, information on the performance of each burner, information on the power supplied to the cooking apparatus 100, size information of the cooking apparatus 100 (e.g., the horizontal length and the vertical length of the cooking apparatus 100), size information of each of the plurality of burners 11, 12, 13 (e.g., the horizontal length and the vertical length of a quadrangle surrounding each of the plurality of burners 11, 12, 13), and location information of each of the plurality of burners 11, 12, 13 (e.g., the horizontal distance and the vertical distance between the vertexes of a quadrangle surrounding each burner and the vertexes of the cooking apparatus), or the like. However, the disclosure is not limited thereto. Accordingly, the cooking apparatus 100 may calculate information on the locations wherein each burner 11, 12, 13 is located on the cooking apparatus 100 based on the information on the specification of the cooking apparatus 100 stored in the memory. A specific content regarding the feature that the cooking apparatus 100 calculates information on the locations of the burners will be described below.

Meanwhile, according to one or more embodiments of the disclosure, the information on the burner that is being used may further include at least one of identification information of the burner that is being used, information on the operation level of the burner that is being used, or information on the time when the burner that is being used started operating.

When any one burner among the plurality of burners 11, 12, 13 operates, the cooking apparatus 100 may store and update information on the operation level of the burner that is operating in the memory. The cooking apparatus 100 may store information on the time when the burner that is operating started operating in the memory. Accordingly, the cooking apparatus 100 may check the identification information of the burner that is being used, the information on the operation level of the burner that is being used, and the information on the time when the burner that is being used started operating based on the information stored in the memory. Accordingly, when a request for information on the cooking apparatus 100 is received from the server 300, the cooking apparatus 100 may identify the burner that is currently being used, and transmit information on the identified burner that is being used to the server 300.

When information on the burner that is being used is received from the cooking apparatus 100, the server 300 may transmit the information on the cooking apparatus 100 requested by the range hood 200 to the range hood 200 in operation S106. Here, the information on the cooking apparatus 100 that the server 300 transmits to the range hood 200 may include the information on the burner that is being used that was received from the cooking apparatus 100.

When the information on the cooking apparatus 300 is received from the server 300, the range hood 200 may generate a streaming session and transmit it to the server 300 in operation S107. Here, in the streaming session generated by the range hood 200, not only a streaming image of the cooking apparatus 100 photographed through the camera, but also the information on the cooking apparatus 100 (in particular, the information on the burner that is being used) received from the server 300 may be included.

When the streaming session is received from the range hood 200, the server 300 may transmit the received streaming session to the display apparatus 400 in operation S108, and the display apparatus 400 may display the streaming image of the cooking apparatus 100 based on the streaming session received from the server 300.

Here, the display apparatus 400 may display various images based on the information on the burner that is being used.

For example, the display apparatus 400 may automatically enlarge the portion of the burner that is currently being used in the streaming image of the cooking apparatus 100, and display the portion, based on information on the location where the burner that is being used is located on the cooking apparatus.

The display apparatus 400 may, based on the identification information of the burner that is being used, display identification information of the burner (e.g., “No. 1 burner,” or the like) together in the enlarged streaming image of the burner that is being used.

Further, the display apparatus 400 may, based on the information on the operation level of the burner that is being used, display information on the operation level of the burner (e.g., “level 3,” or the like) together in the enlarged streaming image of the burner that is being used.

The display apparatus 400 may, based on the information on the time when the burner that is being used started operating, display information on the time when the burner that is being used started operating (e.g., “1:30 pm,” or the like) or information on the time that passed after the burner that is being used started operating (e.g., “1 hour and 35 minutes,” or the like) together in the enlarged streaming image of the burner that is being used.

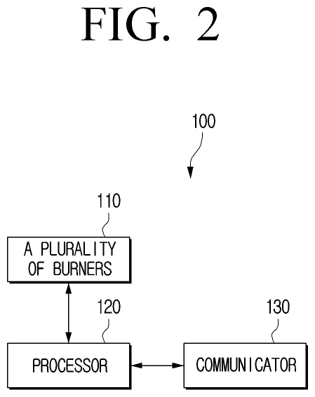

FIG. 2 is a block diagram of the cooking apparatus 100 according to an embodiment of the disclosure.

Referring to FIG. 2, the cooking apparatus 100 includes a plurality of burners 110, a processor 120, and a communicator 130.

Each burner 11, 12, 13 constituting the plurality of burners 110 may include a burner (a gas burner or an electric burner, or the like) and/or an induction coil heating a cooking vessel placed on the upper plate of the cooking apparatus 100. A user may cook a subject for cooking by placing a cooking vessel containing the subject for cooking on a desired burner among the plurality of burners 110, and operating the burner.

The communicator 130 performs communication with the server 300 by various kinds of communication methods according to control by the processor 120.

For this, the communicator 130 may include a wireless LAN communication module (not shown) that is connected with an external network according to a wireless communication protocol, such as Wi-Fi, IEEE, or the like, and performs communication with an external server or an external apparatus. Moreover, the communicator 130 may include a wired communication module (not shown) according to a communication protocol, such as a high-definition multimedia interface (HDMI), a universal serial bus (USB), institute of electrical and electronics engineers (IEEE) 1394, RS-232, RS-422, RS-485, Ethernet, or the like.

Depending on embodiments of the disclosure, the communicator 130 may include a near distance wireless communication module (not shown) for directly communicating with the range hood 200 or the display apparatus 400. Here, the near distance wireless communication module (not shown) is a communication module performing data communication wirelessly with an external apparatus located in a near distance, and it may include, for example, a Bluetooth module, a ZigBee module, a near field communication (NFC) module, an infrared communication module, or the like.

The processor 120 controls the overall operations of the cooking apparatus 100. In particular, if information on the cooking apparatus 100 is requested from an external apparatus based on a streaming request for an image of the cooking apparatus 100 photographed through the camera included in the range hood 200, the processor 120 may control the communicator 130 to transmit the information on the burner that is being used among the plurality of burners 110 to the external apparatus.

Here, the external apparatus may be any one of the server 300, the range hood 200, or the display apparatus 400. Hereinafter, first, various embodiments will be described on the premise of a case wherein the external apparatus is the server 300, as described above in FIG. 1C. Embodiments of cases wherein the external apparatus is the range hood 200 or the display apparatus 400 will be described later.

The processor 120 may receive a request for transmission of information on the cooking apparatus 100 from the server 300 through the communicator 130. Here, the server 300 may request the information on the cooking apparatus 100 to the cooking apparatus 100 based on a streaming request of the display apparatus 400 for an image of the cooking apparatus 100.

When the information on the cooking apparatus 100 is requested from the server 300, the processor 120 may transmit the information on the burner that is being used among the plurality of burners 110 to the server 300.

As described above, the cooking apparatus 100 stores the information on the specification of the cooking apparatus 100 in the memory (not shown). Accordingly, the processor 120 may calculate information on the locations that each of the plurality of burners 110 is located on the cooking apparatus 100 based on the information on the specification of the cooking apparatus 100 stored in the memory.

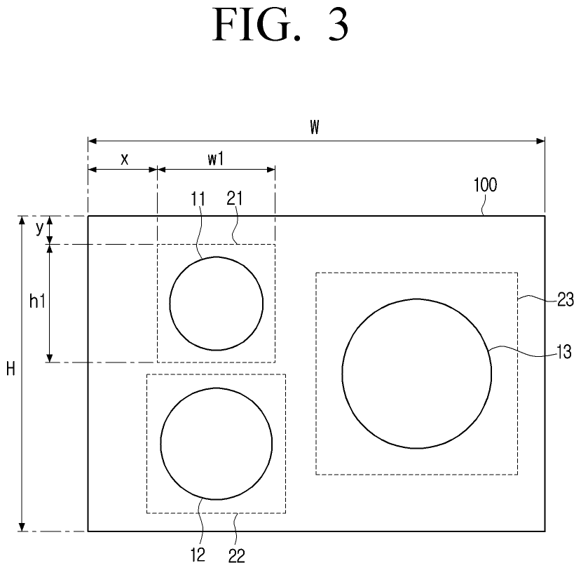

FIG. 3 is a diagram for illustrating a method of calculating information on a location of a burner according to an embodiment of the disclosure.

According to one or more embodiments of the disclosure, the aforementioned information on the locations wherein the burners are located may include information on the coordinates of the vertexes of the quadrangles 21, 22, 23 surrounding each of the plurality of burners 110.

Referring to FIG. 3, it can be figured out that the entire horizontal length of the cooking apparatus 100 is W, the entire vertical length of the cooking apparatus 100 is H, the horizontal length of the burner 11 is w1, the vertical length of the burner 11 is h1, and the horizontal distance between the left upper vertex of the quadrangle 21 surrounding the burner 11 and the left upper vertex of the cooking apparatus 100 is x, and the vertical length is y.

Such information is included in the information on the specification of the cooking apparatus 100, and is stored in the memory (not shown) of the cooking apparatus 100.

Accordingly, for example, if the coordinate of the left upper vertex of the cooking apparatus 100 is assumed as (0, 0), and the coordinate of the right lower vertex of the cooking apparatus 100 is assumed as (100, 100), the processor 120 may calculate the coordinate of the left upper vertex of the burner 11 as ((x/W)*100, (y/H)*100). The processor 120 may calculate the coordinate of the right lower vertex of the burner as (((x+w1)/W)*100, ((y+h1)/H)*100).

In the above, a method of calculating information on the location of the burner 11 was described, but it can be figured out that information on the location of the burner 12 or the burner 13 can also be calculated by a similar method.

According to one or more embodiments of the disclosure, as described above, the processor 120 may calculate information on the locations wherein each 11, 12, 13 of the plurality of burners 110 is located (e.g., the coordinate of the left upper vertex and the coordinate of the right lower vertex of each burner 11, 12, 13), and store it in advance in the memory. Accordingly, when information on the cooking apparatus 100 is requested from the server 300 through the communicator 130, the processor 120 may identify the burner that is being used, and read the information on the location of the burner that is being used from the memory, and directly transmit the information to the server 300.

In addition, according to one or more embodiments of the disclosure, the processor 120 may calculate information on the location of a burner in response to receiving a request for the information on the cooking apparatus 100 from the server 300. For example, when the information on the cooking apparatus 100 is requested from the server 300 through the communicator 130, the processor 120 may identify the burner that is being used, and calculate the information on the location wherein the identified burner is located as described above, and then transmit the information to the server 300.

Meanwhile, when at least one burner among the plurality of burners 11, 12, 13 operates, the processor 120 may identify the information on the operation level of the burner that is operating, and the information on the time when the burner that is operating started operating, and store or update the identified information in the memory (not shown).

Accordingly, when the information on the cooking apparatus 100 is requested from the server 300 through the communicator 130, the processor 120 may identify the burner that is being used in response to the request, and transmit at least one of the identification information of the identified burner, the information on the operation level, or the information on the time when the burner started operating to the server 300 together with the information on the location.

As described above, when the information on the burner that is being used is transmitted to the server 300, the server 300 transmits the information on the cooking apparatus 100 including the information on the burner that is being used to the range hood 200, and the range hood 200 generates a streaming session including an image that photographed the cooking apparatus 100 and the information on the cooking apparatus 100, and transmits it to the server 300.

The server 300 may transmit the streaming session received from the range hood 300 to the display apparatus 400, and the display apparatus 400 may display the streaming image of the cooking apparatus 100 based on the streaming session received from the server 300.

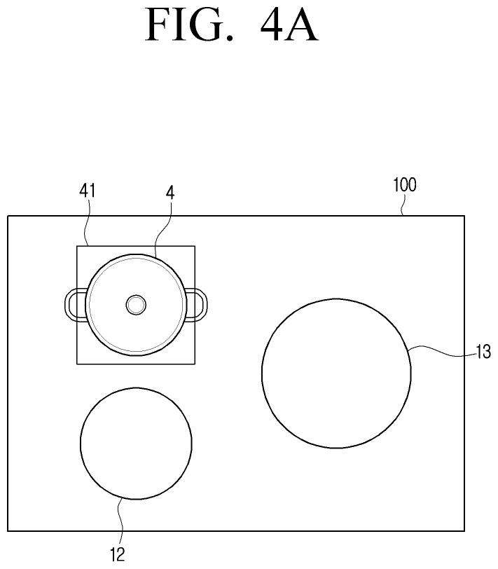

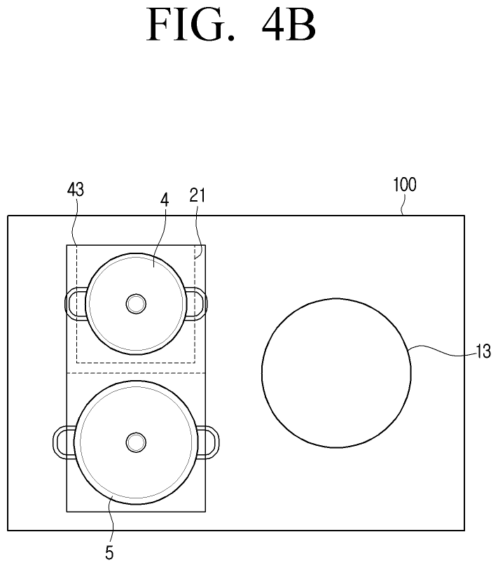

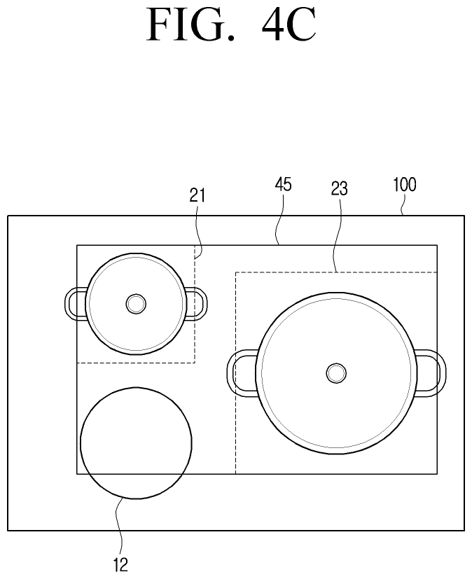

FIGS. 4A, 4B, and 4C are diagrams for illustrating an image displayed on a display apparatus according to an embodiment of the disclosure.

FIG. 4A is a diagram for illustrating a case wherein the burner 11 is being used.

Referring to FIG. 4A, in case a cooking vessel 4 is placed on one burner 11 among the plurality of burners 110 and is being used, the information on the burner that is being used that the processor 120 of the cooking apparatus 100 transmits to the server 300 through the communicator 130 may include the coordinate of the left upper vertex and the coordinate of the right lower vertex of the burner 11.

Accordingly, the display apparatus 400 may, based on the coordinate of the left upper vertex and the coordinate of the right lower vertex of the burner 11 included in the streaming session, display an area 41 corresponding to the burner 11 that is being used in an enlarged size in the entire streaming image of the cooking apparatus 100.

Meanwhile, there may be a case wherein two or more burners among the plurality of burners 110 are being used. In this case, the display apparatus 400 may determine an area of which image will be enlarged based on the leftmost coordinate, the uppermost coordinate, the rightmost coordinate, and the lowermost coordinate among the coordinates of the left upper vertexes and the coordinates of the right lower vertexes of the burners that are being used included in the streaming session, and display the determined area in an enlarged size.

FIG. 4B is a diagram for illustrating a case wherein the burner 11 and the burner 12 are being used.

Referring to FIG. 4B, in case the cooking vessel 4 and the cooking vessel 5 are respectively placed on the burner 11 and the burner 12 among the plurality of burners 110 and are being used, the information on the burners that are being used that the processor 120 of the cooking apparatus 100 transmits to the server 300 through the communicator 130 may include the coordinate of the left upper vertex and the coordinate of the right lower vertex of the burner 11, and the coordinate of the left upper vertex and the coordinate of the right lower vertex of the burner 12.

Accordingly, the display apparatus 400 may, based on the leftmost coordinate (i.e., the x axis coordinate of the coordinate of the left upper vertex of the burner 12), the uppermost coordinate (i.e., the y axis coordinate of the coordinate of the left upper vertex of the burner 11), the rightmost coordinate (i.e., the x axis coordinate of the coordinate of the right lower vertex of the burner 12), and the lowermost coordinate (i.e., the y axis coordinate of the coordinate of the right lower vertex of the burner 12) among the received coordinate information, determine an area 43 corresponding to the burners 11, 12 that are being used in the entire streaming image of the cooking apparatus 100, and display the determined area 43 in an enlarged size.

FIG. 4C is a diagram for illustrating a case wherein the burner 11 and the burner 13 are being used.

Referring to FIG. 4C, in case the burner 11 and the burner 13 among the plurality of burners 110 are being used, the information on the burners that are being used that the processor 120 of the cooking apparatus 100 transmits to the server 300 through the communicator 130 may include the coordinate of the left upper vertex and the coordinate of the right lower vertex of the burner 11, and the coordinate of the left upper vertex and the coordinate of the right lower vertex of the burner 13.

Accordingly, the display apparatus 400 may, based on the leftmost coordinate (i.e., the x axis coordinate of the coordinate of the left upper vertex of the burner 11), the uppermost coordinate (i.e., the y axis coordinate of the coordinate of the left upper vertex of the burner 11), the rightmost coordinate (i.e., the x axis coordinate of the coordinate of the right lower vertex of the burner 13), and the lowermost coordinate (i.e., the y axis coordinate of the coordinate of the right lower vertex of the burner 13) among the received coordinate information, determine an area 45 corresponding to the burners 11, 13 that are being used in the entire streaming image of the cooking apparatus 100, and display the determined area 45 in an enlarged size.

Meanwhile, according to one or more embodiments of the disclosure, as illustrated in FIG. 4B or 4C, in case there is a user's touch input for any one burner area while two or more burners are displayed on the display apparatus 400 in enlarged sizes, the display apparatus 100 may display an area corresponding to the touched burner in a more enlarged size.

Meanwhile, depending on embodiments of the disclosure, at least one of the identification information of the burner that is being used, the information on the operation level, or the information on the operation time may be displayed together in the enlarged areas 41, 43, 45 described above through FIGS. 4A to 4C, as described above.

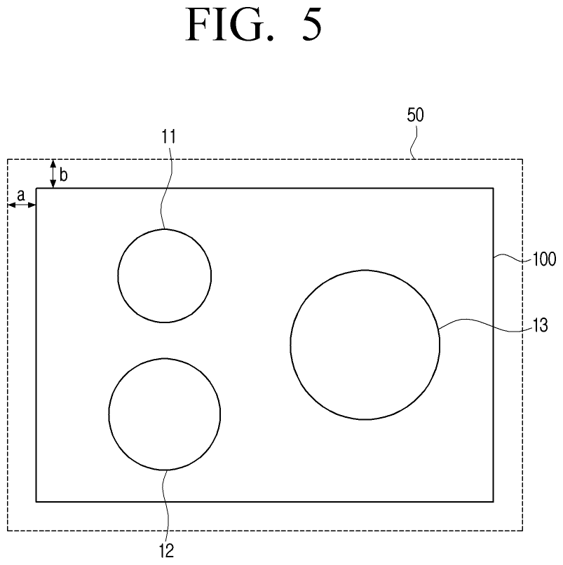

FIG. 5 is a diagram for illustrating a method of calculating information on a location of a burner according to an embodiment of the disclosure. The information on the specification of the cooking apparatus 100 illustrated in FIG. 5 is as illustrated in FIG. 3.

As described above, the cooking apparatus 100 calculates information on the location where the burner that is being used is located on the cooking apparatus 100, assuming that the coordinate of the left upper vertex of the cooking apparatus 100 is (0, 0). The display apparatus 400 determines an area to be enlarged based on the information on the location where the burner that is being used is located on the cooking apparatus 100, provided by the cooking apparatus 100.

Accordingly, if the coordinate of the left upper vertex of the cooking apparatus 100 is not (0, 0) in the image photographed by the range hood 200, the coordinate calculated at the cooking apparatus 100 and the coordinate of the image displayed at the display apparatus 400 may become different, and it may be a problem.

FIG. 5 illustrates a case wherein, based on an image 50 photographed by the range hood 20, the entire horizontal length of the image is W+2a, and the entire vertical length of the image is H+2b. In this case, the aforementioned coordinates calculated at the cooking apparatus 100 need to be corrected.

For this, the cooking apparatus 100 may receive information on the coordinate wherein the cooking apparatus 100 is located (e.g., (a, b)) in the entire image photographed through the camera of the range hood 200 from the server 300.

For example, when the server 300 transmits a streaming request to the range hood 200 in operation S102 in FIG. 1C, the range hood 200 may request information on the cooking apparatus 100 to the server 300, and transmit together information on the coordinate wherein the cooking apparatus 100 is located in the entire image photographed through the camera in operation S103.

The server 300 may request the information on the cooking apparatus 100 to the cooking apparatus 100, and may transmit together the information on the coordinate wherein the cooking apparatus 100 is located in the entire image photographed through the camera of the range hood 200 in operation S104.

Accordingly, the information on the coordinate wherein the cooking apparatus 100 is located in the entire image photographed through the camera of the range hood 200 may be received from the server 300 through the communicator 130.

As described above, when the information on the coordinate wherein the cooking apparatus 100 is located is received, the processor 120 may calculate the coordinates of the vertexes of the quadrangle (e.g., the coordinate of the left upper vertex, the coordinate of the right lower vertex) surrounding each burner 11, 12, 13 based on the received information.

For example, the processor 120 may calculate the coordinate of the left upper vertex of the burner 11 as (((x+a)/(W+2a))*100, ((y+b)/(H+2b))*100). The processor 120 may calculate the coordinate of the right lower vertex of the burner 11 as (((x+a+w1)/(W+2a))*100, ((y+b+h1)/(H+2b))*100).

As described above, according to one or more embodiments of the disclosure, coordinates may be calculated based on an entire image photographed through the camera of the range hood 200, and thus there would be no problem even if coordinates calculated at the cooking apparatus 100 are used as they are.

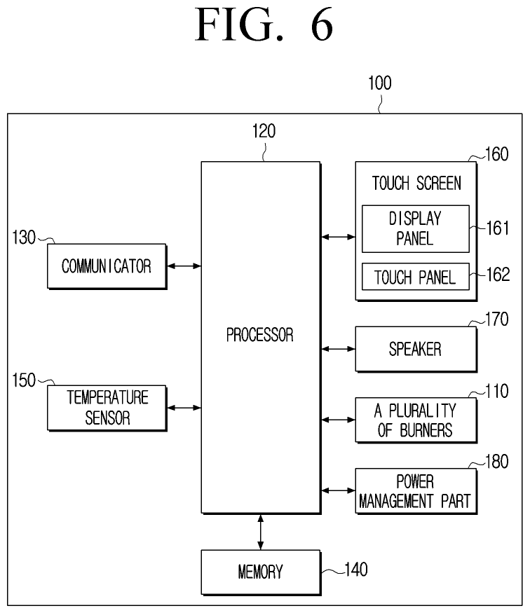

FIG. 6 is a block diagram of the cooking apparatus 100 according to an embodiment of the disclosure. In describing FIG. 6, description regarding contents overlapping with the aforementioned contents will be omitted. Some of the components illustrated in FIG. 6 may be omitted.

Referring to FIG. 6, the cooking apparatus 100 may include a processor 120, a communicator 130, a temperature sensor 150, a touch screen 160, a speaker 170, a plurality of burners 110, a memory 140, and a power management part 180.

The main body of the cooking apparatus 100 may include a processor 120, a communicator 130, a temperature sensor 150, a touch screen 160, a speaker 170, a plurality of burners 110, a memory 140, and a power management part 180.

The cooking apparatus 100 may include a sensor (e.g., an overheating sensor (not shown), or the like). Moreover, the cooking apparatus 100 may further include a microphone (not shown) receiving a user voice.

The memory 140 may store signals or data that are input/output correspondingly to the operations of the components by control by the processor 120. In addition, the memory 140 may store a control program for control of the cooking apparatus 100 or the processor 120 and an application provided from the manufacturer or downloaded from the outside, a graphical user interface (GUI) related to the application, images corresponding to the GUI, user information, documents, databases, or related data.

The memory 140 may store the aforementioned information on the specification of the cooking apparatus 100. Moreover, the memory 140 may store information on the burner that is being used calculated by the processor 120.

The memory 140 may include a non-volatile memory including a ROM storing a control program for control of the cooking apparatus 100, and a volatile memory including a RAM that stores signals or data input from the outside of the cooking apparatus 100, or is used as a storage area for various tasks performed at the cooking apparatus 100.

In addition, the memory 140 may include a memory card (e.g., a micro SD card, or the like, not shown) that can be installed on the cooking apparatus 100. Moreover, the memory 140 may include a hard disc drive (HDD) or a solid state drive (SSD).

The processor 120 performs the functions of controlling the overall operations of the cooking apparatus 100 and flows of signals among the internal components 110 to 180 of the cooking apparatus 100, and processing data. For this, the processor 120 may be implemented as one or more of a central processing unit (CPU), a micro-controller, an application processor (AP) or a communication processor (CP), an ARM processor, and a micom.

The temperature sensor 150 may detect the temperature of a cooking vessel (or, a subject for cooking) placed on the plurality of burners 110. Meanwhile, the cooking apparatus 100 may include a smoke sensor (not shown) detecting the smoke generated from the cooking vessel (or, the subject for cooking) placed on the plurality of burners 110. Meanwhile, it can be easily understood by a person having ordinary skill in the art to which the disclosure belongs that the types of sensors included in the cooking apparatus 100 may be added, changed, or deleted according to the performance of the cooking apparatus 100.

The touch screen (or, the display 160) may provide (or, display) various kinds of GUIs. The touch screen 160 may include a touch panel 162 receiving a user input (e.g., a touch, or the like) and a display panel 161 for displaying a screen. For example, in the touch screen 160, the display panel 161 and the touch panel 162 may be implemented as an integrated type (e.g., an in-cell type touch screen or an on-cell type touch screen).

The touch screen 160 may include an edge touch screen (not shown) having a curvature. The edge touch screen may include an edge touch panel (not shown) receiving a user input and an edge display panel (not shown) for displaying a screen. The edge touch panel and the edge display panel may also be implemented as the aforementioned integrated type.

The touch screen 160 may respectively transmit analog signals corresponding to single touches (or, multi touches) input through the GUI to a touch screen controller (not shown). The touch screen 160 may receive input of a single touch or a multi touch through a user's body (e.g., fingers including a thumb) or an input pen (e.g., a stylus, not shown).

The speaker 170 outputs sounds corresponding to various signals (e.g., a broadcasting signal, an audio source, a video file, or photographing, or the like) decoded by an audio codec by control by the processor 120. The speaker 170 may be one, or a plurality of speakers that are two or more.

The power management part 180 may provide power input from an external power source to each component of the cooking apparatus 100 through a power code (not shown) by control by the processor 120.

The microphone (not shown) generates (or, converts) a voice or a sound received from the outside into an electronic signal by control by the processor 120. An electronic signal generated at the microphone may be converted at the audio codec by control by the processor 120, and may be stored in the memory 140 or output through the speaker 170. The processor 120 may perform control so that voice recognition is performed in its own voice recognition application or a voice recognition application of the outside (or, an outside server) by using a received voice (or, a sound).

Meanwhile, in the above, an example wherein the display apparatus 400 determines an area to be displayed in an enlarged size (i.e., an area corresponding to the burner that is being used) in the streaming image of the cooking apparatus 100 based on the information on the burner that is being used, and displays the determined area in an enlarged size, but embodiments are not limited thereto.

For example, according to one or more embodiments of the disclosure, when the information on the cooking apparatus including the information on the burner that is being used is received from the server 300, the range hood 200 may control the camera to photograph the burner that is being used in an enlarged size based on the received information, and transmit the streaming image photographed in an enlarged size to the server 300. Accordingly, on the display apparatus 400, the area of the burner that is being used may be displayed in an enlarged size.

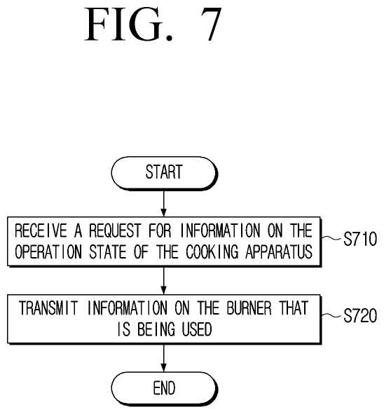

FIG. 7 is a flow chart regarding a controlling method of the cooking apparatus 100 according to an embodiment of the disclosure. Referring to FIG. 7, the cooking apparatus 100 including the plurality of burners 110 for heating food may receive a request for information on the cooking apparatus 100 from an external apparatus based on a streaming request for an image of the cooking apparatus 100 photographed through the camera in operation S710.

The cooking apparatus 100 may transmit information on the burner that is being used among the plurality of burners to the external apparatus in response to the request for information on the cooking apparatus 100 in operation S720.

Here, the information on the burner that is being used may include information on the location where the burner that is being used is located on the cooking apparatus 100. Specifically, the information on the location where the burner that is being used is located on the cooking apparatus 100 may include information on the coordinates of the vertexes of the quadrangle surrounding the burner that is being used among the plurality of quadrangles respectively surrounding the plurality of burners 110.

For example, the cooking apparatus 100 may calculate the coordinates of the left upper vertex and the right lower vertex of the burner that is being used based on the entire horizontal length and the entire vertical length of the cooking apparatus, the horizontal length and the vertical length of the quadrangle surrounding the burner that is being used, and the distance between the vertexes of the quadrangle surrounding the burner that is being used and the vertexes of the cooking apparatus 100.

Moreover, the cooking apparatus 100 may receive information on the coordinate wherein the cooking apparatus 100 is located in the entire image photographed through the camera from the external apparatus, and calculate the coordinates of the vertexes of the quadrangle surrounding the burner that is being used based on the information on the coordinate wherein the cooking apparatus 100 is located.

Meanwhile, according to one or more embodiments of the disclosure, the external apparatus may be the display apparatus 400 wherein a streaming request is initiated, the range hood 200 including the camera, and the server 300 that can communicate with the cooking apparatus 100.

In addition, the server 300 may transmit the information on the burner that is being used that was received from the cooking apparatus 100 to the range hood 200, and transmit a streaming image of the cooking apparatus 100 received from the range hood 200 and the information on the burner that is being used to the display apparatus 400.

In addition, the display apparatus 400 may display the burner that is being used in an enlarged size in the streaming image of the cooking apparatus 100 based on the information on the burner that is being used.

Further, the range hood 200 may control the camera to photograph the burner that is being used in an enlarged size based on the information on the burner that is being used, and transmit a streaming image regarding the burner that is being used that was photographed in an enlarged size to the server 300.

Meanwhile, according to one or more embodiments of the disclosure, the information on the burner that is being used may further include at least one of identification information of the burner that is being used, information on the operation level of the burner that is being used, or information on the time when the burner that is being used started operating.

In the above, explanation was described based on an example wherein the cooking apparatus 100 calculates information on the location of the burner that is being used, but embodiments are not limited thereto. For example, the information on the location of the burner that is being used can be calculated only if there are identification information of the burner that is being used and information on the specification of the cooking apparatus 100, and thus there may be various embodiments.

According to one or more embodiments of the disclosure, the server 300 may calculate information on the location of the burner that is being used.

For example, when information on the cooking apparatus 100 is requested from the server 300, the cooking apparatus 100 may identify the burner that is being used, and transmit the identification information of the identified burner and the information on the specification of the cooking apparatus 100 to the server 300. Accordingly, the server 300 may calculate the information on the location of the burner that is being used as described above based on the information received from the cooking apparatus 100.

Alternatively, for example, the cooking apparatus 100 may be registered in the server 300. In this case, the cooking apparatus 100 may transmit the information on the specification to the server 300 in the registration process, and the server 300 may store the information on the specification of the registered cooking apparatus 100. In this case, when information on the cooking apparatus 100 is requested from the server 300, the cooking apparatus 100 may identify the burner that is being used, and transmit the identification information of the identified burner that is being used to the server 300. Accordingly, the server 300 may calculate the information on the location of the burner that is being used as described above, based on the identification information of the burner that is being used that was received from the cooking apparatus 100 and the information on the specification of the cooking apparatus 100 stored in the registration process. Here, the server 300 may calculate information on the locations of each 11, 12, 13 of the plurality of burners 110 of the cooking apparatus 100 based on the information on the specification of the cooking apparatus 100 and store the information in advance in the memory, and when the identification information of the burner that is being used is received from the cooking apparatus 100, the server 300 may acquire the information on the location of the burner that is being used based on the identification information. Alternatively, when the identification information of the burner that is being used is received from the cooking apparatus 100, the server 300 may calculate the information on the location of the burner that is being used based on the stored information on the specification of the cooking apparatus 100.

Meanwhile, in the two embodiments above, when information on the cooking apparatus 100 is requested from the server 300, the cooking apparatus 100 may further transmit at least one of the information on the operation level of the burner that is being used or the information on the time when the burner that is being used started operating to the server 300.

Accordingly, the server 300 may transmit the information on the cooking apparatus 100 including the information on the burner that is being used to the range hood 200, and the range hood 200 may generate a streaming session including an image that photographed the cooking apparatus 100 and the information on the cooking apparatus 100, and transmit it to the server 300.

Accordingly, the server 300 may transmit the streaming session received from the range hood 300 to the display apparatus 400, and the display apparatus 400 may display the streaming image of the cooking apparatus 100 based on the streaming session received from the server 300.

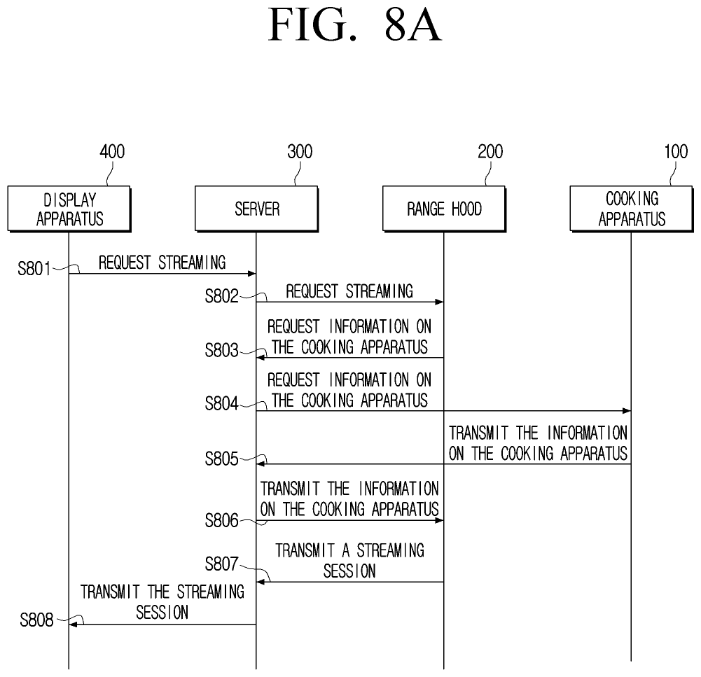

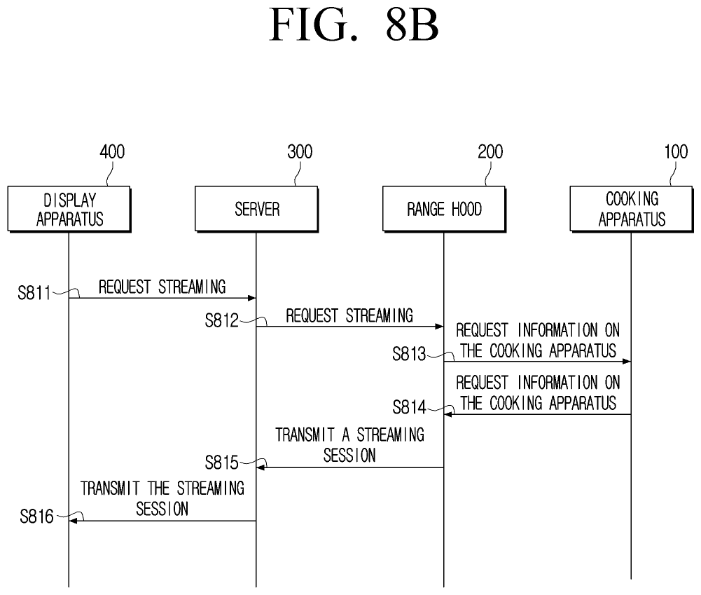

Meanwhile, according to one or more embodiments of the disclosure, the range hood 200 may calculate the information on the location of the burner that is being used. FIGS. 8A and 8B are diagrams for illustrating an embodiment of calculating information on a location of a burner that is being used by the range hood 200 according to various embodiments of the disclosure.

Referring to FIG. 8A, the display apparatus 400 may request streaming of an image of the cooking apparatus 100 to the server 300 in operation S801. When the streaming request is received from the display apparatus 400, the server 300 may request streaming of the image of the cooking apparatus 100 to the range hood 200 in operation S802.

The range hood 200 that received the streaming request may request information on the cooking apparatus 100 to the server 300 for generating a streaming session including the information on the cooking apparatus 100 in operation S803.

The server 300 that received the request for the information on the cooking apparatus 100 from the range hood 200 may request the information on the cooking apparatus 100 to the cooking apparatus 100 in operation S804.

Accordingly, the cooking apparatus 100 may transmit the information on the cooking apparatus 100 including information on a burner that is being used to the server 300 in response to receiving the request for the information on the cooking apparatus 100 from the server 300 in operation S805.

Here, the information on the burner that is being used that the cooking apparatus 100 transmits to the server 300 may include identification information of the burner that is being used and information on the specification of the cooking apparatus 100. The server 300 may transmit the identification information of the burner that is being used and the information on the specification of the cooking apparatus 100 received from the cooking apparatus 300 to the range hood 200 in operation S806, and the range hood 200 may calculate information on the location of the burner that is being used based on the information received from the server 300.

Meanwhile, in case the cooking apparatus 100 is registered in the server 300, and the information on the specification of the cooking apparatus 100 is stored in the server 300, the cooking apparatus 100 may transmit the identification information of the burner that is being used except the information on the specification to the server 300. Accordingly, the server 300 may transmit the identification information of the burner that is being used that was received from the cooking apparatus 100 and the stored information on the specification of the cooking apparatus 100 to the range hood 200 in operation S806, and the range hood 200 may calculate the information on the location of the burner that is being used based on the information received from the server 300.

Meanwhile, depending on embodiments of the disclosure, the information on the burner that is being used that the cooking apparatus 100 transmits to the server 300 may further include at least one of information on the operation level of the burner that is being used or information on the time when the burner that is being used started operating. The server 300 may transmit the information on the operation level of the burner that is being used or the information on the time when the burner that is being used started operating received from the cooking apparatus 100 to the range hood 200 together with the aforementioned information in operation S806.

The range hood 200 may generate a streaming session and transmit it to the server 300 in operation S807. Here, in the streaming session generated by the range hood 200, not only a streaming image of the cooking apparatus 100 photographed through the camera, but also information on the cooking apparatus 100 (e.g., identification information of the burner that is being used, information on the location of the burner that is being used that was calculated by the range hood 200, information on the operation level of the burner that is being used, information on the time when the burner that is being used started operating, or the like) may be included.

When the streaming session is received from the range hood 200, the server 300 may transmit the received streaming session to the display apparatus 400 in operation S808, and the display apparatus 400 may display the streaming image of the cooking apparatus 100 based on the streaming session received from the server 300. Here, examples of various kinds of images that the display apparatus 400 may display based on various kinds of information regarding the burner that is being used are as described above.

Meanwhile, according to one or more embodiments of the disclosure, when information on the location of the burner that is being used is calculated, the range hood 200 may control the camera to photograph the burner that is being used in an enlarged size based on the calculated information, and transmit the streaming image photographed in an enlarged size to the server 300. Accordingly, on the display apparatus 400, the area of the burner that is being used may be displayed in an enlarged size.

FIG. 8B is a diagram for illustrating a range hood directly acquires information on a cooking apparatus from a cooking apparatus according to an embodiment of the disclosure.

Referring to FIG. 8B, the display apparatus 400 may request streaming of an image of the cooking apparatus 100 to the server 300 in operation S811. When the streaming request is received from the display apparatus 400, the server 300 may request streaming of the image of the cooking apparatus 100 to the range hood 200 in operation S812.

The range hood 200 that received the streaming request may request information on the cooking apparatus 100 to the cooking apparatus 100 for generating a streaming session including the information on the cooking apparatus 100 in operation S813, and the cooking apparatus 100 may transmit the information on the cooking apparatus 100 including information on the burner that is being used to the range hood 200 in operation S814. In this case, the range hood 200 and the cooking apparatus 100 may communicate with each other by using a near distance wireless communication method, but the disclosure is not limited thereto.

Here, the information on the burner that is being used that the cooking apparatus 100 transmits to the range hood 200 may include identification information of the burner that is being used and information on the specification of the cooking apparatus 100. Accordingly, the range hood 200 may calculate information on the location of the burner that is being used based on the information received from the cooking apparatus 100.

Meanwhile, in case the cooking apparatus 100 is registered in the server 300, and the information on the specification of the cooking apparatus 100 is stored in the server 300, the cooking apparatus 100 may transmit the identification information of the burner that is being used except the information on the specification to the range hood 200. Here, the information on the specification of the cooking apparatus 100 may be provided from the server 300 to the range hood 200 when the server 300 requests streaming to the range hood 200 in operation S812, but the disclosure is not limited thereto. Accordingly, the range hood 200 may calculate the information on the location of the burner that is being used based on the identification information of the burner that is being used that was received from the cooking apparatus 100 and the information on the specification of the cooking apparatus 100 received from the server 300.

Meanwhile, depending on embodiments of the disclosure, in the operation S814, the cooking apparatus 100 can obviously further transmit at least one of the information on the operation level of the burner that is being used or the information on the time when the burner that is being used started operating to the range hood 200.

When the information on the cooking apparatus 100 is received from the cooking apparatus, and calculation of the information on the location of the burner that is being used is completed as described above, the range hood 200 may generate a streaming session and transmit it to the server 300 in operation S815. Here, in the streaming session generated by the range hood 200, not only a streaming image of the cooking apparatus 100 photographed through the camera, but also various kinds of information regarding the cooking apparatus 100 (e.g., various kinds of information regarding the burner that is being used) may be included.

When the streaming session is received from the range hood 200, the server 300 may transmit the received streaming session to the display apparatus 400 in operation S816, and the display apparatus 400 may display the streaming image of the cooking apparatus 100 based on the streaming session received from the server 300. Here, examples of various kinds of images that the display apparatus 400 may display are as described above.

Meanwhile, according to one or more embodiments of the disclosure, when the information on the location of the burner that is being used is calculated, the range hood 200 may control the camera to photograph the burner that is being used in an enlarged size based on the calculated information, and transmit the streaming image photographed in an enlarged size to the server 300. Accordingly, on the display apparatus 400, the area of the burner that is being used may be displayed in an enlarged size.

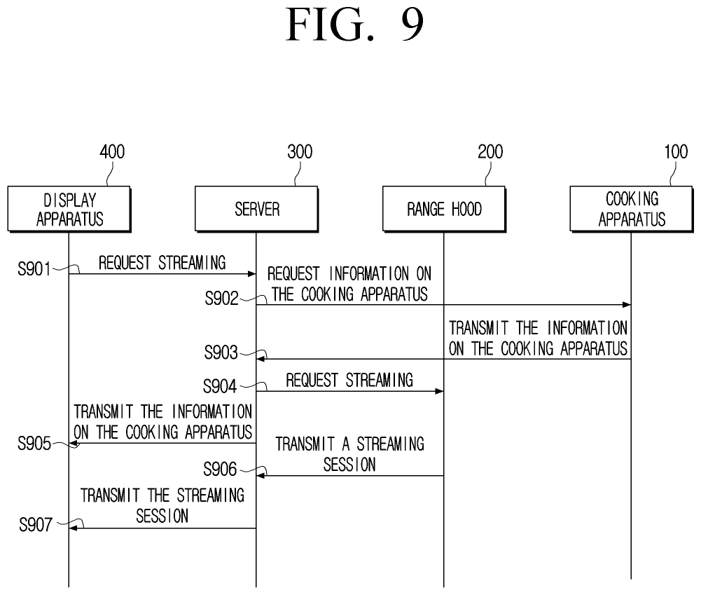

FIG. 9 is a diagram for illustrating calculating and using information on a location of a burner that is being used by a display apparatus according to an embodiment of the disclosure.

Referring to FIG. 9, the display apparatus 400 may request streaming of an image of the cooking apparatus 100 to the server 300 in operation S901.

When the streaming request is received from the display apparatus 400, the server 300 may acquire a streaming image of the cooking apparatus 100 from the range hood 200, and acquire information on the cooking apparatus 100 from the cooking apparatus 100, and provide the acquired streaming image and information on the cooking apparatus 100 to the display apparatus 400.

Accordingly, the display apparatus 400 may calculate information on the location of the burner that is being used based on the information on the cooking apparatus 100, and display the area of the burner that is being used in an enlarged size in the streaming image.

Specifically, referring to FIG. 9, when the streaming request is received from the display apparatus 400, the server 300 may request information on the cooking apparatus 100 to the cooking apparatus 100 in operation S902.

Accordingly, the cooking apparatus 100 may transmit the information on the cooking apparatus 100 including information on the burner that is being used to the server 300 in operation S903. Here, the information on the burner that is being used that the cooking apparatus 100 transmits to the server 300 may include identification information of the burner that is being used and information on the specification of the cooking apparatus 100.

When the information on the cooking apparatus 100 is received from the cooking apparatus 100, the server 300 may request streaming of the image of the cooking apparatus 100 to the range hood 200 in operation S904, and then transmit the information on the cooking apparatus 100 to the display apparatus 400 in operation S905.

Meanwhile, when the range hood 200 transmits a streaming session in operation S906 in response to the request in the operation S904, the server 300 may receive the streaming session and transmit it to the display apparatus 400 in operation S907. Here, in the streaming session received from the range hood 200, the streaming image of the cooking apparatus 100 photographed through the camera of the range hood 200 may be included.

The display apparatus 400 may calculate information on the location of the burner that is being used based on the information on the cooking apparatus 100 received from the server 300, and then display the area of the burner that is being used in an enlarged size in the streaming image.

Depending on embodiments of the disclosure, the information that the cooking apparatus 100 transmits to the server 300 in the operation S903 may further include at least one of information on the operation level of the burner that is being used or information on the time when the burner that is being used started operating. Accordingly, in the operation S905, the server 300 may transmit the information on the operation level of the burner that is being used or the information on the time when the burner that is being used started operating received from the cooking apparatus 100 together to the display apparatus 400. Accordingly, the display apparatus 400 may display the identification information of the burner that is being used, the information on the operation level of the burner that is being used, or the information on the time when the burner that is being used started operating together with the enlarged streaming image.

Meanwhile, in case the cooking apparatus 100 is registered in the server 300, the server 300 may store the information on the specification of the cooking apparatus 100, as described above. Accordingly, in the operation S903, the cooking apparatus 100 may transmit only the identification information of the burner that is being used to the server 300, and in the operation S905, the server 300 may transmit the identification information of the burner that is being used that was received from the cooking apparatus 100 and the prestored information on the specification of the cooking apparatus 100 to the display apparatus 400. Accordingly, the display apparatus 400 may calculate the information on the location of the burner that is being used.

Meanwhile, when a streaming request is received from the display apparatus 400 in operation S901, the server 300 may acquire a streaming image of the cooking apparatus 100 from the range hood 200, and acquire the information on the cooking apparatus 100 from the cooking apparatus 100, and provide the acquired streaming image and information on the cooking apparatus 100 to the display apparatus 400, and the operation order is not limited to what is illustrated in FIG. 9.

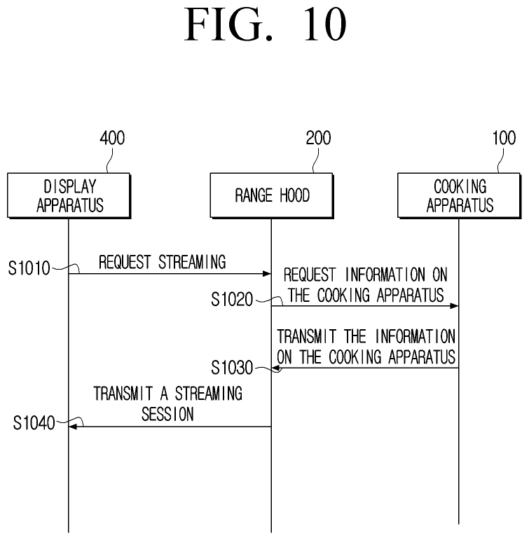

FIG. 10 is a diagram for illustrating providing a streaming image of a cooking apparatus without using a server according to an embodiment of the disclosure. In the example of FIG. 10, the display apparatus 400 and the range hood 200, and the range hood 200 and the cooking apparatus 100 may be communicatively connected with each other by using a near distance communication method.

Referring to FIG. 10, the display apparatus 400 may directly request streaming of an image of the cooking apparatus 100 to the range hood 200 in operation S1010. When the streaming request is received from the display apparatus 400, the range hood 200 may request information on the cooking apparatus 100 to the cooking apparatus 100 for generating a streaming session including the information on the cooking apparatus 100 in operation S1020.

Accordingly, the cooking apparatus 100 may transmit the information on the cooking apparatus 100 including information on the burner that is being used to the range hood 200 in operation S1030. Here, the information on the burner that is being used may include information on the location where the burner that is being used is located on the cooking apparatus 100. The information on the burner that is being used may further include at least one of identification information of the burner that is being used, information on the operation level of the burner that is being used, or information on the time when the burner that is being used started operating.

When the information on the burner that is being used is received from the cooking apparatus 100, the range hood 200 may generate a streaming session and transmit it to the display apparatus 400 in operation S1040. Here, in the streaming session generated by the range hood 200, not only a streaming image of the cooking apparatus 100 photographed through the camera, but also the information on the cooking apparatus 100 (in particular, the information on the burner that is being used) received from the cooking apparatus 100 may be included.

When the streaming session is received from the range hood 200, the display apparatus 400 may display the streaming image of the cooking apparatus 100 based on the received streaming session. Here, the display apparatus 400 may display various images based on the information on the burner that is being used, and this is the same as what was described above.

The number or shape of the burners of the cooking apparatus 100 described above are merely an embodiment of the disclosure, and the disclosure is not limited thereto. For example, the number of the burners of the cooking apparatus 100 may be two or three or more, and the shape of the burners may be a polygon, such as a quadrangle or a pentagon but not a circle.

According to the various embodiments of the disclosure as described above, the display apparatus 400 may automatically enlarge a burner that is currently being used (i.e., a burner that is cooking a subject for cooking) among the plurality of burners 11, 12, 13 and display it, based on information on the cooking apparatus 100 provided at the cooking apparatus 100.

Accordingly, the user can conveniently enlarge and identify the burner that is being used without having to manually manipulate to enlarge (e.g., a pinch to zoom manipulation) a portion of interest (i.e., the portion of the burner that is currently being used) in the entire image of the cooking apparatus 100 displayed on the display apparatus 400.

The area of the burner that is being used may be identified more correctly than in the case of using an image processing method, and may be enlarged.

Meanwhile, the various embodiments of the disclosure may be implemented as software including instructions stored in machine-readable storage media, which can be read by machines (e.g., computers). Here, the machines refer to apparatuses that call instructions stored in a storage medium, and can operate according to the called instructions, and the apparatuses may include the cooking apparatus 100, the hood 200, the server 300, and the display apparatus 400 according to the embodiments disclosed herein.

In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

According to one or more embodiments of the disclosure, methods according to the various embodiments disclosed herein may be provided while being included in a computer program product. A computer program product refers to a product, and it can be traded between a seller and a buyer. A computer program product can be distributed in the form of a storage medium that is readable by machines (e.g., a compact disc read only memory (CD-ROM)), or distributed on-line through an application store (e.g., Play Store™). In the case of on-line distribution, at least a portion of a computer program product may be stored in a storage medium such as the server of the manufacturer, the server of the application store, and the memory of the relay server at least temporarily, or may be generated temporarily.

In addition, each of the components according to the various embodiments (e.g., a module or a program) may consist of a singular object or a plurality of objects. Among the aforementioned corresponding sub-components, some sub-components may be omitted, or other sub-components may be further included in the various embodiments. Alternatively or additionally, some components (e.g., a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A cooking apparatus comprising:
a plurality of burners for heating food;
a communicator; and
at least one processor configured to:
based on information on the cooking apparatus being requested from an external apparatus through the communicator based on a streaming request for an image of the cooking apparatus photographed through a camera, control the communicator to transmit the information on the cooking apparatus including information on a burner that is being used among the plurality of burners to the external apparatus.

2. The cooking apparatus of claim 1, wherein the information on the burner that is being used comprises:
information on a location where the burner that is being used is located on the cooking apparatus.

3. The cooking apparatus of claim 2, wherein the information on the location where the burner that is being used is located comprises:
information on coordinates of vertexes of a quadrangle surrounding the burner that is being used among a plurality of quadrangles respectively surrounding the plurality of burners.

4. The cooking apparatus of claim 3, wherein the at least one processor is further configured to:
based on an entire horizontal length and an entire vertical length of the cooking apparatus, a horizontal length and a vertical length of the quadrangle surrounding the burner that is being used, and a distance between the vertexes of the quadrangle surrounding the burner that is being used and the vertexes of the cooking apparatus, calculate the coordinates of an left upper vertex and a right lower vertex of the burner that is being used.

5. The cooking apparatus of claim 3, wherein the at least one processor is further configured to:
based on receiving the information on the coordinates wherein the cooking apparatus is located in an entire image photographed through the camera from the external apparatus through the communicator, calculate the coordinates of the vertexes of the quadrangle surrounding the burner that is being used based on the information on the coordinates wherein the cooking apparatus is located.

6. The cooking apparatus of claim 1,
wherein the external apparatus is a server that can communicate with a display apparatus wherein the streaming request is initiated, a range hood including the camera, and the cooking apparatus, and
wherein the server is configured to:
transmit the information on the burner that is being used that was received from the cooking apparatus to the range hood, and
transmit a streaming image of the cooking apparatus received from the range hood and the information on the burner that is being used to the display apparatus.

7. The cooking apparatus of claim 6, wherein the display apparatus is configured to:
display the burner that is being used in an enlarged size in the streaming image of the cooking apparatus based on the information on the burner that is being used.

8. The cooking apparatus of claim 6, wherein the range hood is configured to:
control the camera to photograph the burner that is being used in an enlarged size based on the information on the burner that is being used; and
transmit a streaming image regarding the burner that is being used that was photographed in an enlarged size to the server.

9. The cooking apparatus of claim 2, wherein the information on the burner that is being used further comprises:
at least one of identification information of the burner that is being used, information on an operation level of the burner that is being used, or information on a time when the burner that is being used started operating.

10. A method of controlling a cooking apparatus comprising a plurality of burners for heating food, the method comprising:
based on a streaming request for an image of the cooking apparatus photographed through a camera, receiving a request for information on the cooking apparatus from an external apparatus; and
transmitting the information on the cooking apparatus including information on a burner that is being used among the plurality of burners to the external apparatus in response to the request for information.

11. The method of claim 10, wherein the information on the burner that is being used comprises:
information on a location where the burner that is being used is located on the cooking apparatus.

12. The method of claim 11, wherein the information on the location where the burner that is being used is located comprises:
information on coordinates of vertexes of a quadrangle surrounding the burner that is being used among a plurality of quadrangles respectively surrounding the plurality of burners.

13. The method of claim 12, comprising:
based on an entire horizontal length and an entire vertical length of the cooking apparatus, a horizontal length and a vertical length of the quadrangle surrounding the burner that is being used, and a distance between the vertexes of the quadrangle surrounding the burner that is being used and the vertexes of the cooking apparatus, calculating the coordinates of an left upper vertex and a right lower vertex of the burner that is being used.

14. The method of claim 12, comprising:
receiving the information on the coordinates wherein the cooking apparatus is located in an entire image photographed through the camera from the external apparatus; and
calculating the coordinates of the vertexes of the quadrangle surrounding the burner that is being used based on the information on the coordinates wherein the cooking apparatus is located.

15. The method of claim 10,
wherein the external apparatus is a server that can communicate with a display apparatus wherein the streaming request is initiated, a range hood including the camera, and the cooking apparatus, and
wherein the server is configured to:
transmit the information on the burner that is being used that was received from the cooking apparatus to the range hood, and
transmit a streaming image of the cooking apparatus received from the range hood and the information on the burner that is being used to the display apparatus.

16. The method of claim 15, further comprising:
displaying the burner that is being used in an enlarged size in the streaming image of the cooking apparatus based on the information on the burner that is being used.

17. The method of claim 15, further comprising:
controlling the camera to photograph the burner that is being used in an enlarged size based on the information on the burner that is being used; and
transmitting a streaming image regarding the burner that is being used that was photographed in an enlarged size to the server.

18. The method of claim 11, wherein the information on the burner that is being used further comprises:
at least one of identification information of the burner that is being used, information on an operation level of the burner that is being used, or information on a time when the burner that is being used started operating.
